(19) United States
(12) Patent Application Publication
(10) Pub. No.: US 2017/0287219 A1
(43) Pub. Date: Oct. 5, 2017

(54) ELECTROMAGNETIC TRACKING OF OBJECTS FOR MIXED REALITY

(71) Applicants: Adam G. Poulos, Sammamish, WA (US); Daniel Joseph McCulloch, Kirkland, WA (US); Nicholas Gervase Fajt, Seattle, WA (US); Arthur Tomlin, Kirkland, WA (US); Brian Mount, Seattle, WA (US); Lev Cherkashin, Redmond, WA (US); Lorenz Henric Jentz, Seattle, WA (US)

(72) Inventors: Adam G. Poulos, Sammamish, WA (US); Daniel Joseph McCulloch, Kirkland, WA (US); Nicholas Gervase Fajt, Seattle, WA (US); Arthur Tomlin, Kirkland, WA (US); Brian Mount, Seattle, WA (US); Lev Cherkashin, Redmond, WA (US); Lorenz Henric Jentz, Seattle, WA (US)

(21) Appl. No.: 15/087,833

(22) Filed: Mar. 31, 2016

(51) Int. Cl. G06T 19/00; G02B 27/01

(52) U.S. Cl. CPC G06T 19/006; G02B 27/0172; G02B 2027/0174; G02B 2027/0138; G02B 2027/0178

(57) ABSTRACT

A mixed reality system may comprise a head-mounted display (HMD) device with a location sensor from which the HMD device determines a location of the location sensor in space and a base station mounted a predetermined offset from the location sensor and configured to emit an electromagnetic field (EMF). An EMF sensor affixed to an object may be configured to sense a strength of the EMF. The HMD device may determine a location of the EMF sensor relative to the base station based on the sensed strength and determine a location of the EMF sensor in space based on the relative location, the predetermined offset, and the location of the location sensor in space. In some aspects, the HMD device may comprise a see-through display configured to display augmented reality images and overlay a hologram that corresponds to the location of the EMF sensor in space over time.

### BACKGROUND

Recently, various technologies have emerged that allow users to experience a blend of reality and virtual worlds along a mixed reality continuum. For example, head-mounted display (HMD) devices may include various sensors that allow the HMD device to display a blend of reality and virtual objects on the HMD device as augmented reality, or block out the real world view to display only virtual reality. Whether for virtual or augmented reality, a closer tie between real-world features and the display of virtual objects is often desired in order to heighten the interactive experience and provide the user with more control.

One way to bring real-world features into the virtual world is to track a handheld controller through space as it is being used. However, some conventional controllers lack precise resolution and users end up with choppy, inaccurate display of the virtual objects. Some handheld controllers even require externally positioned cameras, tethering use of the HMD device to a small area. Similarly, some physical object tracking systems use stationary transmitters with a short transmission range, also tethering the user to a small area.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A mixed reality system may comprise a head-mounted display (HMD) device with a location sensor from which the HMD device determines a location of the location sensor in space and a base station mounted at a fixed position relative to the HMD device a predetermined offset from the location sensor and configured to emit an electromagnetic field (EMF). The system may further comprise an EMF sensor affixed to an object and configured to sense a strength of the EMF. The HMD device may determine a location of the EMF sensor relative to the base station based on the sensed strength and determine a location of the EMF sensor in space based on the relative location, the predetermined offset, and the location of the location sensor in space. In some aspects, the HMD device may comprise an opaque or see-through display configured to display virtual or augmented reality images, respectively, and overlay a hologram that corresponds to the location of the EMF sensor in space over time.

### BRIEF DESCRIPTION OF THE DRAWINGS

FIG. 1 shows a schematic illustration of a head-mounted display (HMD) device.

FIG. 2 shows an example software-hardware diagram of a mixed reality system including the HMD device.

FIG. 3 shows an example calibration configuration for the mixed reality system.

FIG. 4 shows an example augmented reality situation of the mixed reality system.

FIG. 5 shows an example virtual reality situation of the mixed reality system.

FIG. 6 shows a flowchart for a method of locating an object in the mixed reality system.

FIG. 7 shows a computing system according to an embodiment of the present description.

### DETAILED DESCRIPTION

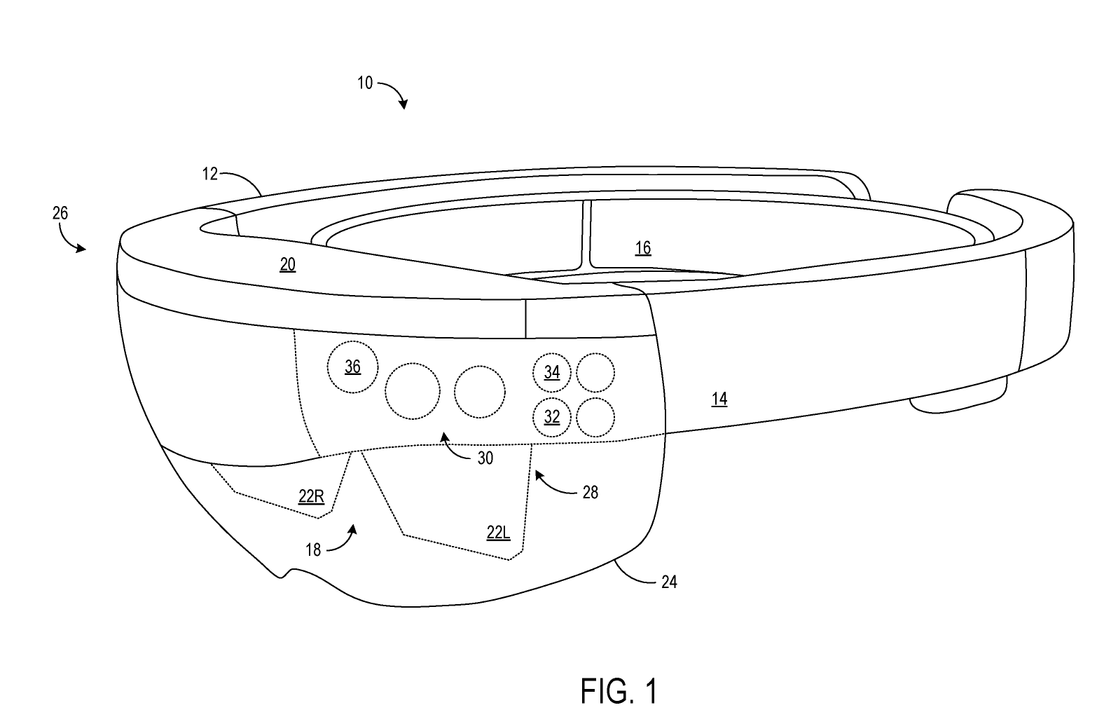

FIG. 1 shows a schematic illustration of a head-mounted display (HMD) device 10, which may be part of a mixed reality system 100 (described later). The illustrated HMD device 10 takes the form of a wearable visor, but it will be appreciated that other forms are possible, such as glasses or goggles, among others. The HMD device 10 may include a housing 12 including a band 14 and an inner band 16 to rest on a user's head. The HMD device 10 may include a display 18 which is controlled by a controller 20. The display 18 may be a stereoscopic display and may include a left panel 22L, and a right panel 22R as shown, or alternatively, a single panel of a suitable shape. The panels 22L, 22R are not limited to the shape shown and may be, for example, round, oval, square, or other shapes including lens-shaped. The HMD device 10 may also include a shield 24 attached to a front portion 26 of the housing 12 of the HMD device 10. The display 18 and/or the shield 24 may include one or more regions that are transparent, opaque, or semi-transparent. Any of these portions may further be configured to change transparency by suitable means. As such, the HMD device 10 may be suited for both augmented reality situations and virtual reality situations.

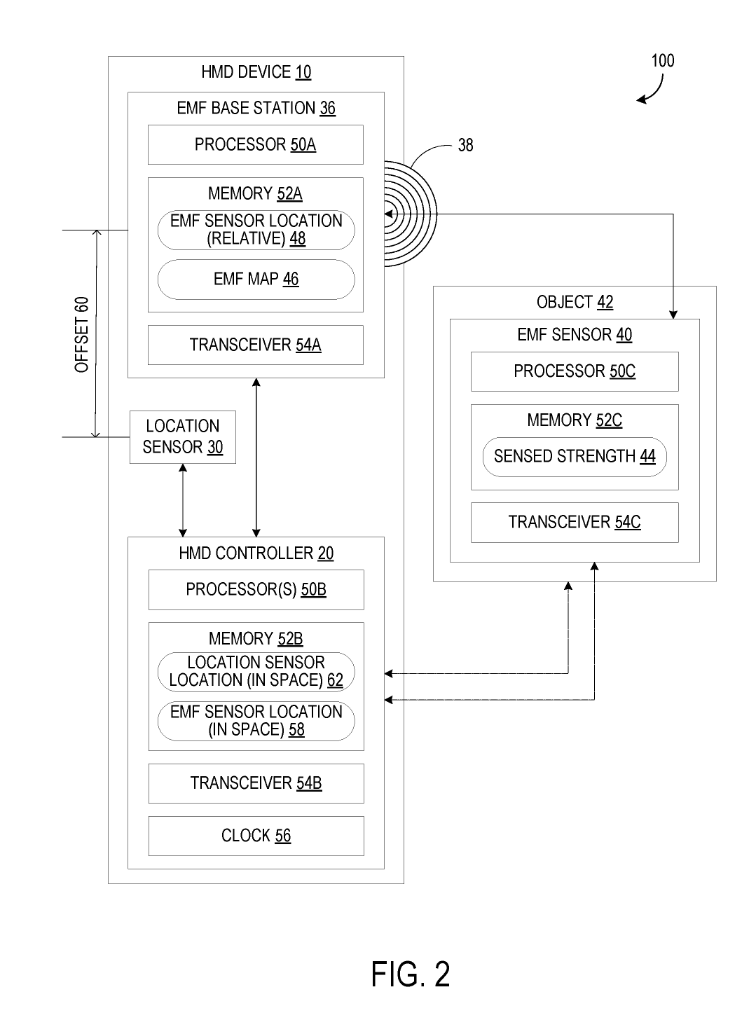

The head-mounted display (HMD) device 10 may comprise a position sensor system 28 which may include one or more sensors such as optical sensor(s) like depth camera(s) and RGB camera(s), accelerometer(s), gyroscope(s), magnetometer(s), global positioning system(s) (GPSs), multilateration tracker(s), and/or other sensors that output position sensor information useable to extract a position, e.g., (X, Y, Z), orientation, e.g., (pitch, roll, yaw), and/or movement of the relevant sensor. Of these, the position sensor system 28 may include one or more location sensor 30 from which the HMD device 10 determines a location 62 (see FIG. 2) of the location sensor 30 in space. As used herein, a “location” may be a “pose” and may include position and orientation for a total of six values per location. For example, the location sensor 30 may be at least one camera, and as depicted, may be a camera cluster. The position sensor system 28 is also shown as including at least an accelerometer 32 and gyroscope 34.

The HMD device 10 may include a base station 36 mounted at a fixed position relative to the HMD device 10 a predetermined offset 60 (see FIG. 2) from the location sensor 30. In the depicted example, the base station 36 may be positioned in the front portion 26 of the housing 12 of the HMD device 10 where the base station 36 is rigidly supported and unlikely to move relative to the HMD device 10. The base station 36 may be configured to emit an electromagnetic field 38, discussed below with reference to FIG. 2.

FIG. 2 shows an example software-hardware diagram of the mixed reality system 100 including the HMD device 10. In addition to the HMD device 10, the mixed reality system 100 may also include an electromagnetic field sensor 40 affixed to an object 42 and configured to sense a strength 44 of the electromagnetic field 38. The electromagnetic field sensor 40 may be incorporated into the object 42 or may be in the form of a removably mountable sensor which may be temporarily affixed to the object 42 via adhesives, fasteners, etc., such that the object 42 being tracked may be swapped out and may thus be a wide variety of objects.

The electromagnetic field 38 may propagate in all directions, and may be blocked or otherwise affected by various materials, such as metals, or energy sources, etc. When the base station 36 is rigidly supported at a fixed location relative to the HMD device 10, components of the HMD device 10 which are known to cause interference may be accounted for by generating an electromagnetic field map 46 of various sensed strengths 44 each measured at a known relative location 48. Furthermore, when the base station 36 is positioned in the front portion 26 of the housing 12, fewer sources of interference may be present between the base station 36 and the electromagnetic field sensor 40, and when the user of the HMD device 10 is holding or looking at the object 42, then the range of the base station 36 may be utilized to its full potential by positioning the base station 36 in front of the user at all times.

The base station 36 may include a processor 50A configured to execute instructions stored in memory 52A and a transceiver 54A that allows the base station to communicate with the electromagnetic field sensor 40 and/or controller 20. The base station 36 may also be configured to communicate over a wired connection, which may decrease latency in the mixed reality system 100. The controller 20 may include one or more processors 50B configured to execute instructions stored in memory 52B and a transceiver 54B that allows the controller to communicate with the electromagnetic field sensor 40, the base station 36, and/or other devices. Further, the electromagnetic field sensor 40 may include a processor 50C configured to execute instructions stored in memory 52C and a transceiver 54C that allows the electromagnetic field sensor 40 to wirelessly communicate with the base station 36 and/or controller 20. Wireless communication may occur over, for example, WI-FI, BLUETOOTH, or a custom wireless protocol. It will be appreciated that a transceiver may comprise one or more combined or separate receiver and transmitter.

The electromagnetic field map 46 which correlates the known pattern of the electromagnetic field 38 emitted by the base station 36 to the sensed strength 44 at various relative locations within the range of the base station 36 may be stored in the memory 52A, 52B, and/or 52C. In order to synchronize measurements performed by the pair of the electromagnetic field sensor 40 and the base station 36 with measurements performed by the location sensor 30, the controller 20 may include a common clock 56 to provide timestamps for data reporting from multiple sources.

The HMD device 10 may include a processor, which may be the processor 50A or the processor 50B, configured to determine a location 48 of the electromagnetic field sensor 40 relative to the base station 36 based on the sensed strength 44. The processor may be configured to determine a location 58 of the electromagnetic field sensor 40 in space based on the relative location 48, the predetermined offset 60, and the location 62 of the location sensor 30 in space. If the location sensor is a camera, for example, the camera may be configured to send the controller 20 one or more images from which the controller may, via image recognition, determine the location of the location sensor 30 in space. If the location sensor is a GPS receiver paired with an accelerometer, as another example, then the location 62 of the location sensor 30 may be determined by receiving the position from the GPS receiver and the orientation may be determined by the accelerometer. In one case, the electromagnetic field sensor 40 may be configured to communicate the sensed strength 44 to the base station 36 or the controller 20, and the base station 36 or controller 20 may be configured to determine the location 48 of the electromagnetic field sensor 40 relative to the base station 36 based on the sensed strength 44. Alternatively, the processor 50C of the electromagnetic field sensor 40 may be configured to determine the location 48 of the electromagnetic field sensor 40 relative to the base station 36 based on the sensed strength 44 and communicate the location 48 of the electromagnetic field sensor 40 relative to the base station 36, to the base station 36 or controller 20. In the former case, the HMD device 10 may lower a processing burden of the electromagnetic field sensor 40 by determining the relative location 48 itself, while in the latter case, performing the relative location determination processing or even some pre-processing at the electromagnetic field sensor 40 may lower a communication burden of the electromagnetic field sensor 40.

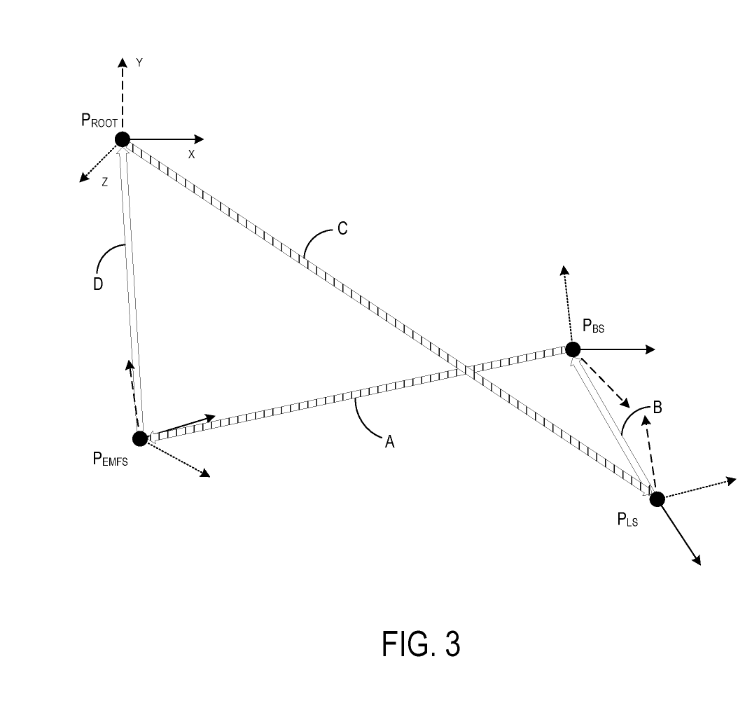

FIG. 3 shows an example calibration configuration for the mixed reality system 100. During calibration, the electromagnetic field sensor 40 may be kept at a fixed position in the real world, denoted as P_{EMFS}. Measurements may be taken at precisely coordinated times by both the electromagnetic field sensor 40 and the location sensor 30 as the HMD device 10 is moved along a motion path that includes combined rotation and translation to cause changes in each value measured (X, Y, Z, pitch, roll, yaw) by the location sensor 30 to account for the effect that motion has on each value measured by the electromagnetic field sensor 40. Thus, the calibration may be performed by a robot in a factory where full six degree of freedom control can be ensured. In FIG. 3, like axes are shown with like lines to indicate varying orientations.

As the HMD device 10 is moved along the motion path, the measurements taken over time may include data relating to the location of the location sensor 30 (P_{LS}), the location of the base station 36 (P_{BS}), the location of the electromagnetic field sensor 40 (P_{EMFS}), and the location of an arbitrary fixed point in the real world relative to which the HMD device 10 reports its location (P_{ROOT}). This fixed point P_{ROOT} may be, for example, the location of the HMD device 10 when it is turned on or a current software application starts, and the fixed point may be kept constant throughout an entire use session of the HMD device 10. The HMD device 10 may be considered to “tare” or “zero” its position in space by setting the fixed point P_{ROOT} as the origin (0,0,0,0,0,0) and reporting the current location of the location sensor as coordinates relative thereto.

The measurements taken during calibration may include a matrix or transform A representing the temporarily-fixed real-world point P_{EMFS} relative to the moving location P_{BS}, and a matrix or transform C representing the moving location P_{LS} relative to the fixed real-world point P_{ROOT}. The matrix A may correspond to measurements taken by the electromagnetic field sensor 40 and the matrix C may correspond to measurements taken by the location sensor 30. In FIG. 3, transforms which are measured are shown as striped arrows, while previously unknown transforms to be calculated during calculation are shown as white arrows. The transforms A, B, C, and D form a closed loop in FIG. 3. Therefore, once sufficient data has been collected, an optimization algorithm may be performed to converge on a single solution for the matrices or transforms B and D in Equation 1 below, where I is an identity matrix of an appropriate size.

A×B×C×D=I Equation 1:

Solving for the matrix B may provide the predetermined offset 60, which may be six values including three dimensions of position and three dimensions of orientation, which may then be used during normal operation to align measurements of the electromagnetic field sensor 40 and the location sensor 30 to the same reference point. Thus, during normal operation of the HMD device 10, in order to determine the location 58 of the electromagnetic field sensor 40 in space, the processor 50A, 50B, or 50C may be configured to offset the location 62 of the location sensor 30 in space by the predetermined offset 60 to determine the location of the base station 36 in space. Then, the processor 50A, 50B, or 50C may be configured to offset the location of the base station 36 in space by the location 48 of the electromagnetic field sensor 40 relative to the base station 36.

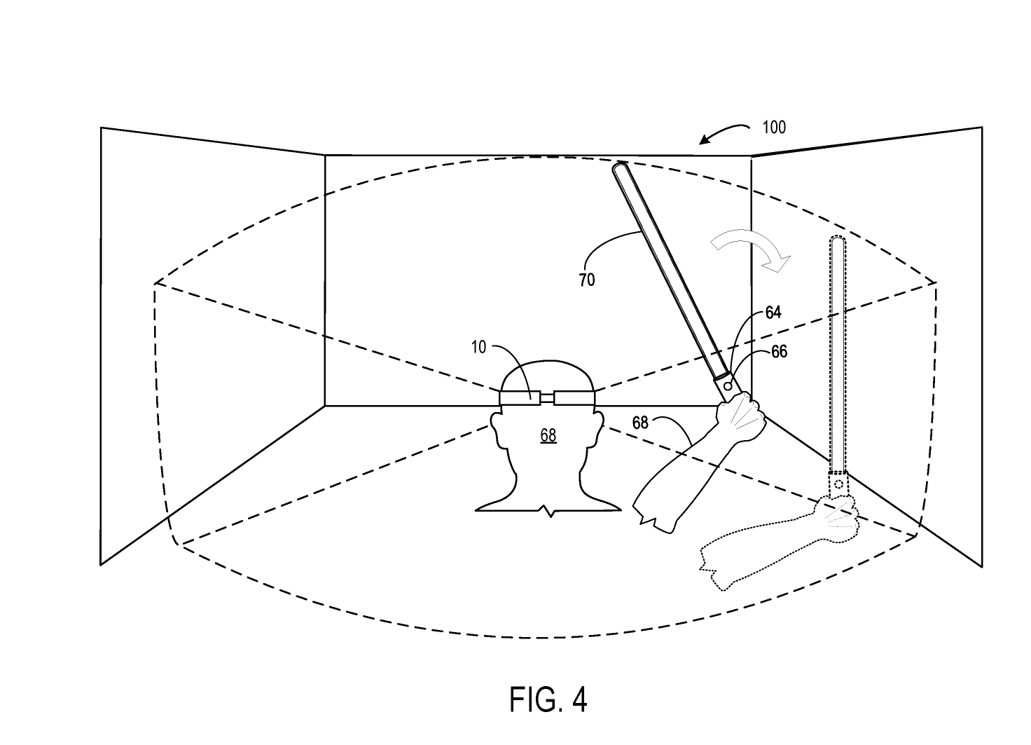

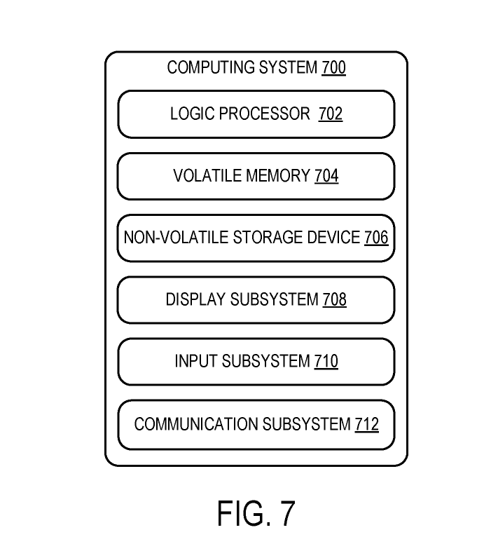

FIG. 4 shows an example augmented reality situation of the mixed reality system. As discussed above with reference to FIG. 1, the HMD device 10 may comprise the display 18 which may be an at least partially see-through display configured to display augmented reality images, which may be controlled by the controller 20. In the example shown, the object 42 may be a handheld input device 64 such as a video game controller configured to provide user input to the HMD device 10. To provide such functionality, the handheld input device 64 may comprise its own processor, memory, and transceiver, among other components, discussed below with reference to FIG. 7. The handheld input device 64 may also comprise one or more input widgets 66 such as a button, joystick, directional pad, touch screen, accelerometer, gyroscope, etc.

In the example of FIG. 4, a user 68 may view an augmented reality scene with the HMD device 10, shown here in dashed lines. The user 68 may hold the handheld input device 64 with his hand and move the handheld input device 64 over time from a first position, shown in solid lines, to a second position, shown in clotted lines. By tracking the location 58 of the electromagnetic field sensor 40 of the handheld input device 64 as discussed above, the display 18 may be further configured to overlay a hologram 70 that corresponds to the location 58 of the electromagnetic field sensor 40 in space over time. In this example, the hologram 70 may be a glowing sword which incorporates the real handheld input device 64 as a hilt and follows the handheld input device 64 as it is waved around in space by the user 68. When rendering the virtual or augmented reality image, the mixed reality system 100 may experience increased accuracy and decreased latency compared to other HMD devices that use, for example, external cameras to locate objects. Furthermore, the depicted user 68 is free to move to other areas while continuing to wear and operate the HMD device 10 without disrupting the current use session or losing track of the handheld input device 64.

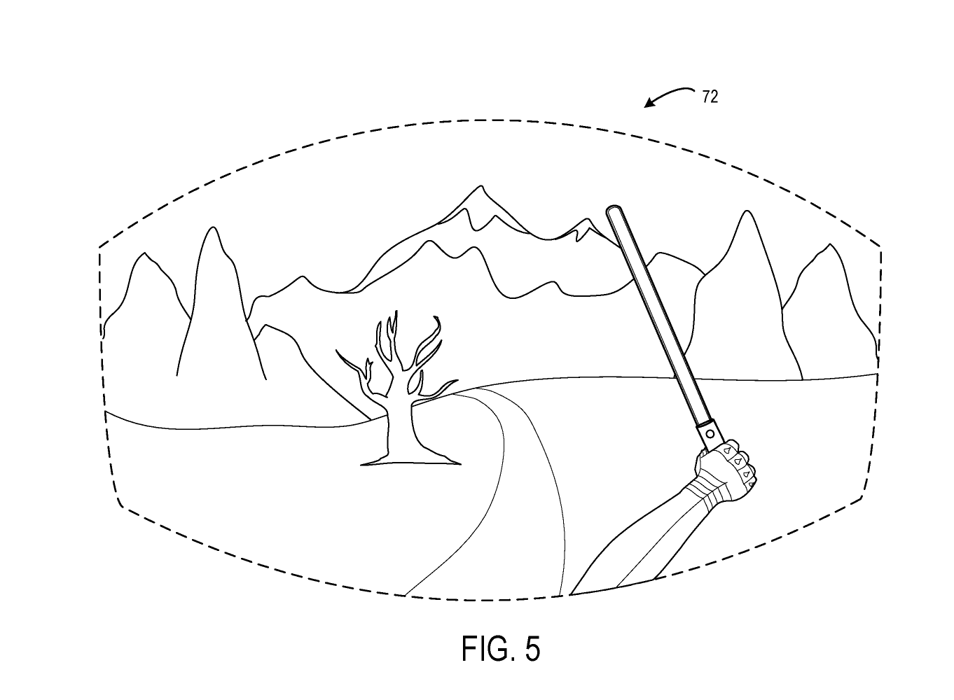

FIG. 5 shows an example virtual reality situation of the mixed reality system 100, similar to the augmented reality situation discussed above. As discussed above, the HMD device 10 may comprise the display 18 which may be an at least partially opaque display configured to display virtual reality images 72, and may further be a multimodal display which is configured to switch to an opaque, virtual reality mode. As above, the display 18 may be controlled by the controller 20. Rather than the hologram 70 in the augmented reality situation above, FIG. 5 shows virtual reality images 72 such as a tree and mountains in the background, a gauntlet which corresponds to the user's hand, and the glowing sword which moves together with the handheld input device 64 in the real world.

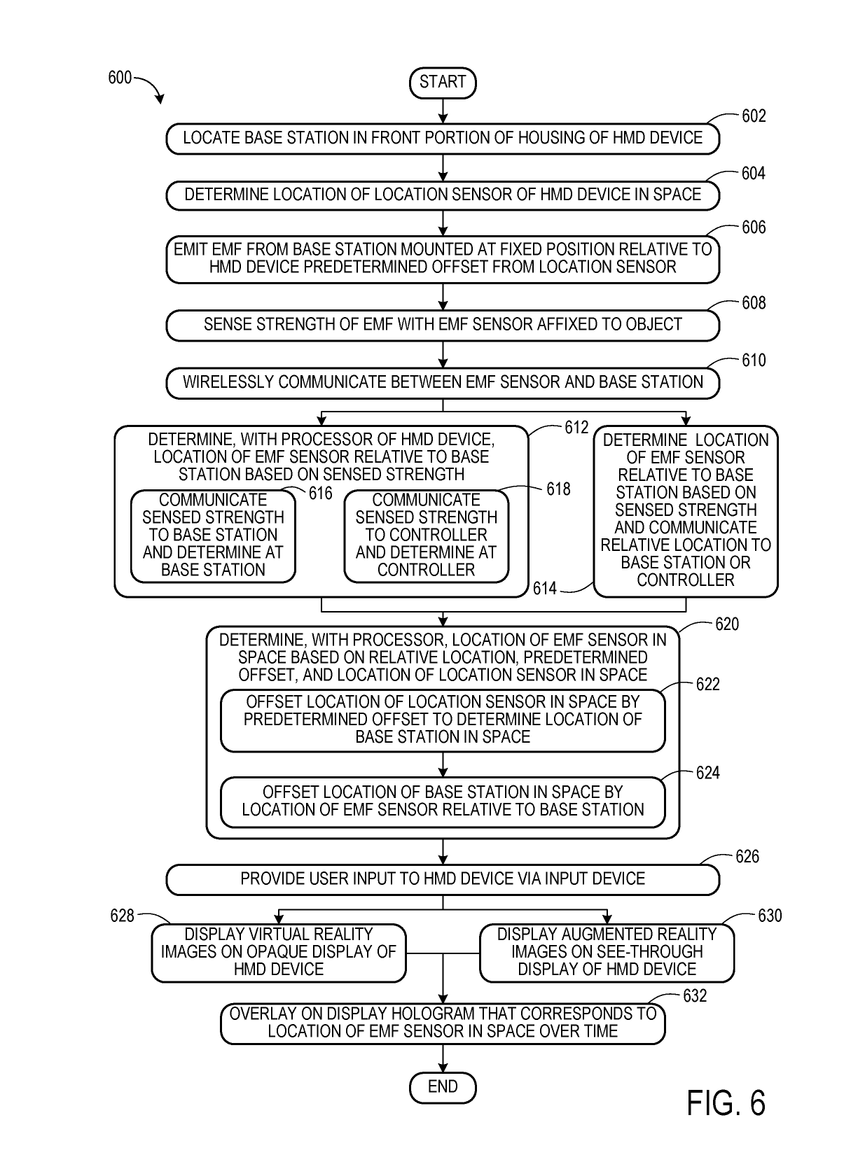

FIG. 6 shows a flowchart for a method 600 of locating an object in a mixed reality system. The following description of method 600 is provided with reference to the mixed reality system 100 described above and shown in FIG. 2. It will be appreciated that method 600 may also be performed in other contexts using other suitable components.

With reference to FIG. 6, at 602, the method 600 may include positioning a base station in a front portion of a housing of a head-mounted display (HMD) device. When the object to be located is located in front of a user wearing the HMD device, which is likely when the user is looking at or holding the object in her hands, positioning the base station in the front portion of the housing may increase accuracy, decrease noise filtering performed to calculate accurate values, and allow for a decrease in the range of the base station without negatively impacting performance. At 604, the method 600 may include determining a location of a location sensor of the HMD device in space. As mentioned above, the location sensor may include an accelerometer, a gyroscope, a global positioning system, a multilateration tracker, or one or more optical sensors such as a camera, among others. Depending on the type of sensor, the location sensor itself may be configured to determine the location, or the controller may be configured to calculate the location of the location sensor based on data received therefrom. In some instances, the location of the location sensor may be considered the location of the HMD device itself.

At 606, the method 600 may include emitting an electromagnetic field from the base station mounted at a fixed position relative to the HMD device a predetermined offset from the location sensor. The base station may be rigidly mounted near the location sensor to minimize movement between the sensors, and a precise value of the predetermined offset may be determined when calibrating the HMD device as discussed above. At 608, the method 600 may include sensing a strength of the electromagnetic field with an electromagnetic field sensor affixed to the object. The object may be an inert physical object, a living organism, or a handheld input device, for example.

At 610, the electromagnetic field sensor may comprise a transceiver and the method 600 may include wirelessly communicating between the electromagnetic field sensor and the base station. Alternatively, any of the base station, the electromagnetic field sensor, and a controller of the HMD device may be connected via a wired connection. At 612, the method 600 may include determining, with a processor of the HMD device, a location of the electromagnetic field sensor relative to the base station based on the sensed strength. Alternatively, at 614, the method 600 may include, at a processor of the electromagnetic sensor, determining the location of the electromagnetic field sensor relative to the base station based on the sensed strength and then communicating the relative location to the base station or controller. In such a case, the processor of the HMD device, which may be of the base station or of the controller, may be considered to determine the relative location by receiving the relative location from the electromagnetic field sensor. If calculation is performed at a processor of the HMD device to determine the relative location at 612, then at 616, the method 600 may include communicating the sensed strength to the base station and determining, at the base station, the location of the electromagnetic field sensor relative to the base station based on the sensed strength. Similarly, at 618, the method 600 may include communicating the sensed strength to the controller and determining, at the controller, the location of the electromagnetic field sensor relative to the base station based on the sensed strength. Various determination processing may be distributed in a suitable manner among the various processors of the mixed reality system to lower the amount of raw data transmitted or lower the power of the processors included, for example.

At 620, the method 600 may include determining, with the processor, a location of the electromagnetic field sensor in space based on the relative location, the predetermined offset, and the location of the location sensor in space. In one example, determining the location of the electromagnetic field sensor in space at 620 may include, at 622, offsetting the location of the location sensor in space by the predetermined offset to determine a location of the base station in space, and at 624, offsetting the location of the base station in space by the location of the electromagnetic field sensor relative to the base station. At 626, when the object is a handheld input device, the method 600 may include providing user input to the HMD device via the input device. In such a situation, the handheld input device may be used for six degree of freedom input. For each of steps 620-624, the processor may be the processor of the base station or of the controller of the HMD device, or even of the electromagnetic field sensor in some cases.

At 628, the method 600 may include displaying virtual reality images on an at least partially opaque display of the HMD device. At 630, the method 600 may include displaying augmented reality images on an at least partially see-through display of the HMD device. Whether opaque or see-through, the display may be controlled by the controller of the HMD device. As discussed above, the display may be configured to switch between opaque and see-through modes, or vary by degrees therebetween. Whether operating in an augmented reality mode or a virtual reality mode, at 632, the method 600 may include overlaying on the display a hologram that corresponds to the location of the electromagnetic field sensor in space over time. As the location of the electromagnetic field sensor changes, the controller may render images on the display to move the hologram in a corresponding manner, whether the hologram is directly overlaid on the location, is a fixed distance away from the location, or is a changing distance away from the location. In such a manner, the hologram may be seemingly seamlessly integrated with the real-world environment to the user.

The above mixed reality system and method of locating an object therein may utilize a paired electromagnetic base station and sensor to track the object affixed to the sensor. The base station may be mounted in an HMD device such that the entire mixed reality system is untethered from any particular environment and easily operated within view of a user wearing the HMD device. Furthermore, the base station may be rigidly mounted at a location that is a predetermined offset from a location sensor of the HMD such that rendered images displayed on a display of the HMD device may accurately follow the movement of the object with lower latency than conventional mixed reality devices.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more head-mounted display devices as shown in FIG. 1, or one or more devices cooperating with a head-mounted display device (e.g., personal computers, server computers, tablet computers, home-entertainment computers, network computing devices, gaming devices, mobile computing devices, mobile communication devices (e.g., smart phone), the handheld input device 64, and/or other computing devices).

Computing system 700 includes a logic processor 702, volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built-in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module.” “program,” and “engine” may encompass individual or groups of executable files, data files, libraries, drivers, scripts, database records, etc.

When included, display subsystem 708 may be used to present a visual representation of data held by non-volatile storage device 706. This visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices. The at least partially opaque or see-through display of HMD device 10 described above is one example of a display subsystem 708.

When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; any of the sensors described above with respect to position sensor system 28 of FIG. 1; and/or any other suitable sensor.

When included, communication subsystem 712 may be configured to communicatively couple computing system 700 with one or more other computing devices. Communication subsystem 712 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

The subject matter of the present disclosure is further described in the following paragraphs. One aspect provides a mixed reality system may comprise a head-mounted display (HMD) device comprising a location sensor from which the HMD device determines a location of the location sensor in space, and a base station mounted at a fixed position relative to the HMD device a predetermined offset from the location sensor and configured to emit an electromagnetic field, and an electromagnetic field sensor affixed to an object and configured to sense a strength of the electromagnetic field. The HMD device may include a processor configured to determine a location of the electromagnetic field sensor relative to the base station based on the sensed strength, and determine a location of the electromagnetic field sensor in space based on the relative location, the predetermined offset, and the location of the location sensor in space. In this aspect, the HMD device may further comprise an at least partially opaque display configured to display virtual reality images. In this aspect, the HMD device may further comprise an at least partially see-through display configured to display augmented reality images. In this aspect, the display may be further configured to overlay a hologram that corresponds to the location of the electromagnetic field sensor in space over time. In this aspect, the electromagnetic field sensor may be configured to communicate the sensed strength to the base station and the base station is configured to determine the location of the electromagnetic field sensor relative to the base station based on the sensed strength. In this aspect, the electromagnetic field sensor may be configured to determine the location of the electromagnetic field sensor relative to the base station based on the sensed strength and communicate the location of the electromagnetic field sensor relative to the base station, to the base station. In this aspect, the object may be a handheld input device configured to provide user input to the HMD device. In this aspect, the location sensor may be at least one camera. In this aspect, the electromagnetic field sensor may comprise a transceiver to wirelessly communicate with the base station. In this aspect, the base station may be positioned in a front portion of a housing of the HMD device. In this aspect, in order to determine the location of the electromagnetic field sensor in space, the processor may be configured to offset the location of the location sensor in space by the predetermined offset to determine a location of the base station in space, and offset the location of the base station in space by the location of the electromagnetic field sensor relative to the base station.

According to another aspect, a method of locating an object in a mixed reality system may comprising determining a location of a location sensor of a head-mounted display (HMD) device in space, emitting an electromagnetic field from a base station mounted at a fixed position relative to the HMD device a predetermined offset from the location sensor, sensing a strength of the electromagnetic field with an electromagnetic field sensor affixed to the object, determining, with a processor of the HMD device, a location of the electromagnetic field sensor relative to the base station based on the sensed strength, and determining, with the processor, a location of the electromagnetic field sensor in space based on the relative location, the predetermined offset, and the location of the location sensor in space. In this aspect, the method may further comprise displaying augmented reality images on an at least partially see-through display of the HMD device. In this aspect, the method may further comprise overlaying on the display a hologram that corresponds to the location of the electromagnetic field sensor in space over time. In this aspect, the method may further comprise communicating the sensed strength to the base station and determining, at the base station, the location of the electromagnetic field sensor relative to the base station based on the sensed strength. In this aspect, the object may be a handheld input device and the method may further comprise providing user input to the HMD device via the input device. In this aspect, the electromagnetic field sensor may comprise a transceiver and the method may further comprise wirelessly communicating between the electromagnetic field sensor and the base station. In this aspect, the method may further comprise positioning the base station in a front portion of a housing of the HMD device. In this aspect, determining the location of the electromagnetic field sensor in space may comprises offsetting the location of the location sensor in space by the predetermined offset to determine a location of the base station in space, and offsetting the location of the base station in space by the location of the electromagnetic field sensor relative to the base station.

According to another aspect, a mixed reality system may comprise an electromagnetic field sensor affixed to an object and configured to sense a strength of an electromagnetic field, and a head-mounted display (HMD) device comprising a location sensor from which the HMD device determines a location of the location sensor in space, a base station mounted at a fixed position relative to the HMD device a predetermined offset from the location sensor and configured to emit the electromagnetic field, a processor configured to determine a location of the electromagnetic field sensor relative to the base station based on the sensed strength, and determine a location of the electromagnetic field sensor in space based on the relative location, the predetermined offset, and the location of the location sensor in space, and an at least partially see-through display configured to display augmented reality images and overlay a hologram that corresponds to the location of the electromagnetic field sensor in space over time.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A mixed reality system comprising:
a head-mounted display (HMD) device comprising:
a location sensor from which the HMD device determines a location of the location sensor in space; and
a base station mounted at a fixed position relative to the HMD device a predetermined offset from the location sensor and configured to emit an electromagnetic field; and
an electromagnetic field sensor affixed to an object and configured to sense a strength of the electromagnetic field;
wherein the HMD device includes a processor configured to:
determine a location of the electromagnetic field sensor relative to the base station based on the sensed strength; and
determine a location of the electromagnetic field sensor in space based on the relative location, the predetermined offset, and the location of the location sensor in space.

2. The mixed reality system of claim 1, wherein the HMD device further comprises an at least partially opaque display configured to display virtual reality images.

3. The mixed reality system of claim 1, wherein the HMD device further comprises an at least partially see-through display configured to display augmented reality images.

4. The mixed reality system of claim 3, wherein the display is further configured to overlay a hologram that corresponds to the location of the electromagnetic field sensor in space over time.

5. The mixed reality system of claim 1, wherein the electromagnetic field sensor is configured to communicate the sensed strength to the base station and the base station is configured to determine the location of the electromagnetic field sensor relative to the base station based on the sensed strength.

6. The mixed reality system of claim 1, wherein the electromagnetic field sensor is configured to determine the location of the electromagnetic field sensor relative to the base station based on the sensed strength and communicate the location of the electromagnetic field sensor relative to the base station, to the base station.

7. The mixed reality system of claim 1, wherein the object is a handheld input device configured to provide user input to the HMD device.

8. The mixed reality system of claim 1, wherein the location sensor is at least one camera.

9. The mixed reality system of claim 1, wherein the electromagnetic field sensor comprises a transceiver to wirelessly communicate with the base station.

10. The mixed reality system of claim 1, wherein the base station is positioned in a front portion of a housing of the HMD device.

11. The mixed reality system of claim 1, wherein, to determine the location of the electromagnetic field sensor in space, the processor is configured to:
offset the location of the location sensor in space by the predetermined offset to determine a location of the base station in space; and
offset the location of the base station in space by the location of the electromagnetic field sensor relative to the base station.

12. A method of locating an object in a mixed reality system, the method comprising:
determining a location of a location sensor of a head-mounted display (HMD) device in space;
emitting an electromagnetic field from a base station mounted at a fixed position relative to the HMD device a predetermined offset from the location sensor;
sensing a strength of the electromagnetic field with an electromagnetic field sensor affixed to the object;
determining, with a processor of the HMD device, a location of the electromagnetic field sensor relative to the base station based on the sensed strength; and
determining, with the processor, a location of the electromagnetic field sensor in space based on the relative location, the predetermined offset, and the location of the location sensor in space.

13. The method of claim 12, further comprising displaying augmented reality images on an at least partially see-through display of the HMD device.

14. The method of claim 13, further comprising overlaying on the display a hologram that corresponds to the location of the electromagnetic field sensor in space over time.

15. The method of claim 12, further comprising communicating the sensed strength to the base station and determining, at the base station, the location of the electromagnetic field sensor relative to the base station based on the sensed strength.

16. The method of claim 12, wherein the object is a handheld input device and the method further comprises providing user input to the HMD device via the input device.

17. The method of claim 12, wherein the electromagnetic field sensor comprises a transceiver and the method further comprises wirelessly communicating between the electromagnetic field sensor and the base station.

18. The method of claim 12, further comprising positioning the base station in a front portion of a housing of the HMD device.

19. The method of claim 12, wherein determining the location of the electromagnetic field sensor in space comprises:
offsetting the location of the location sensor in space by the predetermined offset to determine a location of the base station in space; and
offsetting the location of the base station in space by the location of the electromagnetic field sensor relative to the base station.

20. A mixed reality system comprising:
an electromagnetic field sensor affixed to an object and configured to sense a strength of an electromagnetic field; and
a head-mounted display (HMD) device comprising:
a location sensor from which the HMD device determines a location of the location sensor in space;
a base station mounted at a fixed position relative to the HMD device a predetermined offset from the location sensor and configured to emit the electromagnetic field;
a processor configured to:
determine a location of the electromagnetic field sensor relative to the base station based on the sensed strength; and
determine a location of the electromagnetic field sensor in space based on the relative location, the predetermined offset, and the location of the location sensor in space; and
an at least partially see-through display configured to display augmented reality images and overlay a hologram that corresponds to the location of the electromagnetic field sensor in space over time.
